(19) United States
(12) Patent Application Publication
(10) Pub. No.: US 2019/0376433 A1
(43) Pub. Date: Dec. 12, 2019

(54) ON-BOARD DIAGNOSTIC METHOD FOR MONITORING DIESEL OXIDATION CATALYST FUNCTION VIA BRICK TEMPERATURE RISE

(71) Applicant: GM Global Technology Operations LLC, Detroit, MI (US)

(72) Inventors: Michelle H. Wiebenga, Farmington Hills, MI (US); Se H. Oh, Troy, MI (US); Giovanni Montinaro, Turin (IT)

(21) Appl. No.: 16/006,148

(22) Filed: Jun. 12, 2018

(51) Int. Cl. F01N 11/00; G07C 5/08

(52) U.S. Cl. CPC F01N 11/002; G07C 5/0808; F01N 2550/02; F01N 2900/1404; G07C 5/0841

(57) ABSTRACT

A method for monitoring diesel oxidation catalyst function via a brick temperature rise includes pre-storing hydrocarbons on a catalyst coating in a catalyst coated body. A diesel oxidation catalyst (DOC) exhaust treatment device is positioned in an exhaust conduit of a diesel engine. The DOC exhaust treatment device includes the catalyst coated body. A first exhaust gas temperature output defining an inlet gas temperature received in the DOC exhaust treatment device is forwarded to a control module. A time for the inlet gas temperature to reach a target temperature is recorded in the control module. The time for the inlet gas temperature to reach the target temperature is compared in the control module to a time required for a brick temperature of the catalyst coated body to reach the same target temperature.

### INTRODUCTION

The present disclosure relates to engine exhaust systems and, more specifically, to an apparatus and method for monitoring the health of a diesel oxidation catalyst (DOC) in an engine exhaust stream.

Significant interest has been focused on the reduction of certain constituents in diesel engine exhaust, particularly during engine startup. Diesel engine exhaust typically contains gaseous emissions such as unburned hydrocarbons (HC), carbon monoxide (CO), and oxides of nitrogen (NOx) including NO and NO₂, along with solid and/or liquid condensed phase materials referred to as particulates. Treatment of diesel engine exhaust may involve various catalytic devices having one or more catalysts disposed on a substrate for reducing the levels of regulated constituents in the diesel exhaust. For example, diesel exhaust treatment systems may include an oxidation catalyst, also known as a diesel oxidation catalyst (DOC), to convert HC and CO to CO₂ and water, a catalyst for the reduction of NOx, and a particulate filter, also known as a diesel particulate filter (DPF), for removal of particulates.

It is required to have the capability, on board of a vehicle, to monitor the conversion efficiency and the health of a DOC exhaust treatment device. Unburned hydrocarbons are stored on the DOC device and are oxidized in an exothermic reaction when the DOC device warms up. In existing diagnostic systems, exhaust gas temperature (EGT) sensors are placed in the exhaust gas both upstream and downstream of the DOC device. During startup, the measured temperature of the downstream EGT sensor is compared to the prediction of an inert model to determine if the DOC device is functioning. If the EGT sensor temperature is a predetermined percentage higher than the inert model, the DOC device is assumed to be functioning correctly, however the criterion for this temperature comparison can vary with the degree of aging and/or vehicle operating conditions, and a measured downstream gas temperature does not yield as accurate an indication of DOC health as would the measured temperature of the DOC device itself. False failure indications can also result. Accordingly, it is desirable to provide a system and method for improved diagnostic measurement of a DOC exhaust treatment device.

Thus, while current diesel engine exhaust systems achieve their intended purpose, there is a need for a new and improved system and method for monitoring diesel oxidation catalyst function.

### SUMMARY

According to several aspects, a method for monitoring diesel oxidation catalyst function via a brick temperature rise includes: positioning a diesel oxidation catalyst (DOC) exhaust treatment device in an exhaust conduit receiving exhaust from a diesel engine, the DOC exhaust treatment device having a catalyst coated body; measuring an inlet gas temperature to the DOC exhaust treatment device and forwarding the inlet gas temperature to a control module; recording a time for the inlet gas temperature to reach a target temperature in the control module; and comparing in the control module the time for the inlet gas temperature to reach the target temperature to a time required for a brick temperature of the catalyst coated body to reach the same target temperature.

In another aspect of the present disclosure, the method further includes positioning a first exhaust gas temperature sensor in the exhaust conduit upstream of the DOC exhaust treatment device.

In another aspect of the present disclosure, the method further includes positioning a second exhaust gas temperature sensor within the catalyst coated body, an output signal from the second exhaust gas temperature sensor forwarded to the control module and defining the brick temperature of the catalyst coated body.

In another aspect of the present disclosure, the method further includes: creating a bore in the catalyst coated body adapted to receive the second exhaust gas temperature sensor; and fixing the second exhaust gas temperature sensor within the bore.

In another aspect of the present disclosure, the method further includes positioning the second exhaust gas temperature sensor within the bore proximate to a longitudinal centerline of the catalyst coated body.

In another aspect of the present disclosure, the method further includes storing hydrocarbons on a catalyst coating in the catalyst coated body.

In another aspect of the present disclosure, the determining step further includes measuring the brick temperature.

In another aspect of the present disclosure, the determining step further includes predicting a temperature immediately inside an inlet face of the DOC exhaust treatment device via a mathematical model using the measured inlet gas temperature.

In another aspect of the present disclosure, the method further includes: generating the brick temperature of the catalyst coated body using an exhaust gas temperature sensor positioned within the catalyst coated body; and forwarding an output signal from the exhaust gas temperature sensor to the control module.

In another aspect of the present disclosure, the method further includes: creating a bore in the catalyst coated body adapted to receive the exhaust gas temperature sensor; and positioning the exhaust gas temperature sensor within the bore.

According to several aspects, a method for monitoring diesel oxidation catalyst function via a brick temperature rise includes: pre-storing hydrocarbons on a catalyst coating in a catalyst coated body; positioning a diesel oxidation catalyst (DOC) exhaust treatment device in an exhaust conduit of a diesel engine, the DOC exhaust treatment device including the catalyst coated body; forwarding a first exhaust gas temperature output defining an inlet gas temperature received in the DOC exhaust treatment device to a control module; recording in the control module a time for the inlet gas temperature to reach a target temperature; and comparing in the control module the time for the inlet gas temperature to reach the target temperature to a time required for a brick temperature of the catalyst coated body to reach the same target temperature.

In another aspect of the present disclosure, the method further includes positioning a first exhaust gas temperature sensor in the exhaust conduit upstream of the DOC exhaust treatment device to provide the first exhaust gas temperature output.

In another aspect of the present disclosure, the method further includes positioning a second exhaust gas temperature sensor within the catalyst coated body to generate the brick temperature of the catalyst coated body.

In another aspect of the present disclosure, the target temperature is approximately 275 degrees Centigrade.

In another aspect of the present disclosure, the target temperature ranges between approximately 150 degrees Centigrade to 350 degrees Centigrade.

In another aspect of the present disclosure, if the time for the brick temperature of the catalyst coated body to reach the target temperature is less than the time for the inlet gas temperature to reach the target temperature, a DOC healthy signal is generated.

In another aspect of the present disclosure, if the time for the inlet gas temperature to reach the target temperature is less than the time required for the brick temperature of the catalyst coated body to reach the target temperature, a DOC un-healthy signal is generated.

According to several aspects, a method for monitoring diesel oxidation catalyst function via a brick temperature rise, comprises: measuring a first exhaust gas temperature sensor outputting a first exhaust gas temperature for an exhaust conduit collecting exhaust from a diesel engine; positioning a diesel oxidation catalyst (DOC) exhaust treatment device in the exhaust conduit downstream of the first exhaust gas temperature sensor, the DOC exhaust treatment device having a catalyst coated body; incorporating a second exhaust gas temperature sensor in the catalyst coated body of the DOC exhaust treatment device; forwarding an output signal from each of the first exhaust gas temperature sensor defining an inlet gas temperature received in the DOC exhaust treatment device, and an output signal from the second exhaust gas temperature sensor defining a brick temperature of the catalyst coated body to a control module; recording in the control module a time for the inlet gas temperature to reach a target temperature; and comparing in the control module the time for the inlet gas temperature to reach the target temperature to a time required for the brick temperature of the catalyst coated body to reach the same target temperature.

In another aspect of the present disclosure, if the time for the brick temperature of the catalyst coated body to reach the target temperature is less than the time for the inlet gas temperature to reach the same target temperature a DOC healthy signal is generated; or if the time for the inlet gas temperature to reach the target temperature is less than the time required for the brick temperature of the catalyst coated body to reach the target temperature, a DOC un-healthy signal is generated.

In another aspect of the present disclosure, the method further includes incorporating the second exhaust gas temperature sensor in a bore of the catalyst coated body along a longitudinal axis of the catalyst coated body.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of an exhaust treatment system according to exemplary aspects of the present disclosure;

FIG. 2 is a schematic view of a diesel engine connected to a DOC device according to an exemplary embodiment;

FIG. 3 is a schematic view of a diesel engine connected to a DOC device modified from FIG. 2;

FIG. 4 is a graph depicting temperature range and time comparing outlet gas temperatures for known DOC devices; and

FIG. 5 is a graph depicting temperature range and time comparing outlet gas temperatures for DOC devices of the present disclosure;

FIG. 6 is a partial cross sectional front elevational view of a DOC device of the present disclosure showing temperature sensor locations;

and

FIG. 7 is a graph 78 identifying the difference in time between when an inlet gas temperature reaches a target temperature and when other given locations reach the same target temperature along a plot line presenting data points for successive temperature sensor positions for the DOC of FIG. 6, with negative values indicating the catalyst brick reaches the target temperature before the inlet gas.

### DETAILED DESCRIPTION

The following description is merely exemplary in nature and is not intended to limit the present disclosure, application, or uses.

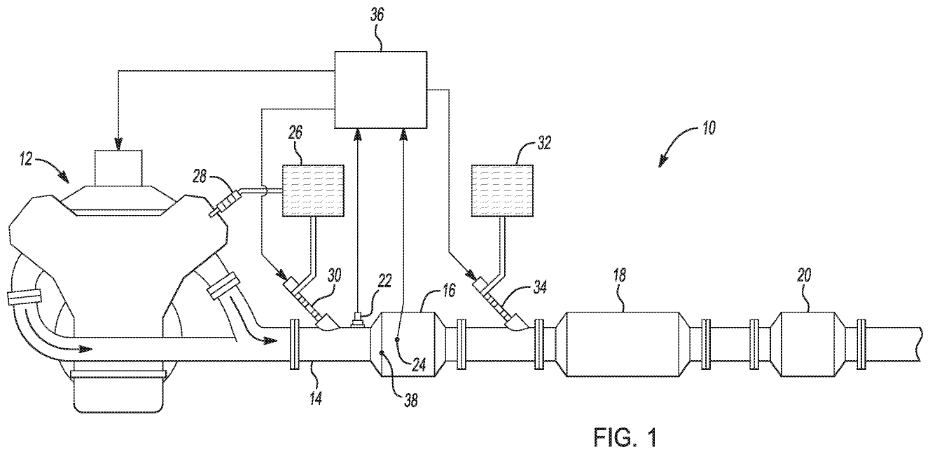

Referring to FIG. 1, an exhaust treatment system 10 provides a vehicle on-board diagnostic method for monitoring diesel oxidation catalyst function via a brick temperature rise for reduction of regulated components of engine exhaust from an internal combustion engine such as diesel engine 12. The exhaust treatment system 10 includes an exhaust conduit 14, which collects exhaust from the diesel engine 12 and transports it to the treatment devices in the system, such as a diesel oxidation catalyst (DOC) device 16, an SCR catalyst 18, and a particulate filter 20. A first exhaust gas temperature sensor 22 measures the oxidation catalyst temperature upstream of the DOC device 16. A second exhaust gas temperature sensor 24 is embedded within the catalyst body of the DOC device 16 and measures the oxidation catalyst temperature, or brick temperature within the DOC device 16. Other sensors (not shown), such as additional temperature sensors, oxygen sensors, ammonia sensors, and the like may be incorporated at various positions in the exhaust treatment system 10 as is known in the art.

According to several aspects, a fuel source 26 is connected to one or more fuel injectors 28 such that fuel injection can be carried out into the engine cylinders of the engine 12 for combustion, by modifying the timing of the fuel injection to inject fuel into the engine cylinders during their exhaust stroke, thus eliminating the need for a separate downstream fuel injector 30. In other exemplary aspects as commonly practiced in the art, the fuel source 26 is connected to the fuel injector 30 for injecting fuel into the engine exhaust stream upstream of the DOC device 16. In this exemplary aspect, the fuel injector 30 is shown positioned in the exhaust stream downstream of the engine 12, which conceptually represents the injection of fuel into the exhaust stream, also known as “post injection”.

A reductant source 32 is connected to a reductant injector 34 for injecting a reductant into the engine exhaust stream upstream of the SCR catalyst 18 to enhance the effectiveness of the SCR catalyst 18 at reducing NOx emissions. The reductant may include any known reducing agent, such as ammonia or urea. Urea is commonly used as a reducing agent for motor vehicle exhaust SCR treatment schemes, and is also referred to as diesel exhaust fluid (DEF) by the U.S. Environmental Protection Agency.

A control module 36 receives inputs from the first exhaust gas temperature sensor 22 and the second exhaust gas temperature sensor 24 and communicates output temperature signals to the fuel injectors 28, 30 and the reductant injector 34. The control module 36 also receives input data and communicates output settings to various components in the engine 12, as well as other sensors and devices in other on-board vehicle systems. The control module 36 may be any known type of control module, such as a microprocessor coupled with a storage medium containing data and instructions for controlling the exhaust treatment system 10 and for carrying out methods according to exemplary aspects of the present disclosure, or other equivalent art known electronic control unit.

In accordance with exemplary aspects of the present disclosure, the control module 36 diagnoses NO to NO₂ conversion efficiency of the DOC device 16, and performs initial engine start diagnostics of the proper functioning of the DOC device 16, which can in turn provide useful information regarding the efficiency of the SCR 18 in reducing NOx emissions and can control engine operating parameters for effective exhaust warm-up and optimization of urea solution (DEF) dosing rate accordingly. In so doing, the control module 36 relies on a relationship of a temperature differential between the inlet of the DOC device 16 and the catalyst of the DOC device 16 during periods of engine start operation.

In accordance with further aspects of the present disclosure, and as discussed in reference to FIG. 3 below, a modeled inlet brick temperature 38 can be used in place of the output from the second exhaust gas temperature sensor 24. The control module 36 implements the modeled inlet brick temperature 38 using diagnostic functions described below.

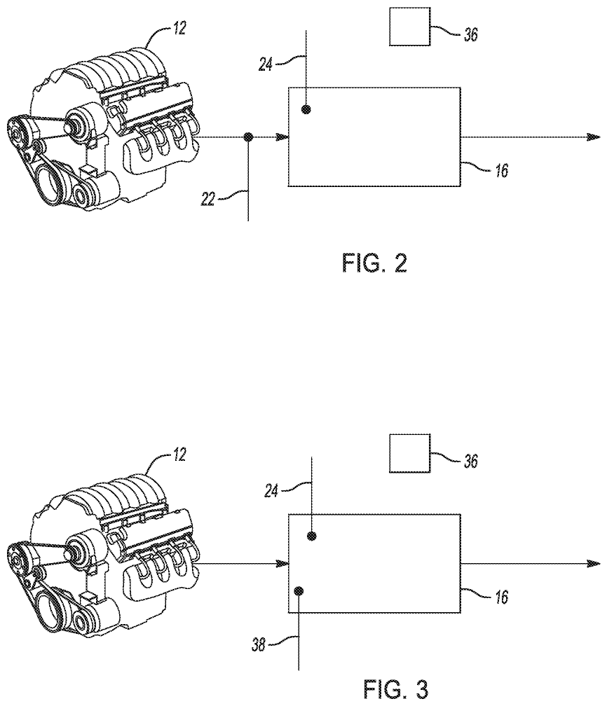

Referring to FIG. 2 and again to FIG. 1, from a cold engine 12 start, the exhaust treatment system 10 functions as follows using the temperature signals from the first exhaust gas temperature sensor 22 and the second exhaust gas temperature sensor 24. When the ignition is keyed on, the control module 36 begins recording the outputs from each of the first exhaust gas temperature sensor 22 and the second exhaust gas temperature sensor 24. A first time, t₁ seconds, from the key-on event for the first exhaust gas temperature sensor 22 to reach a target temperature T_{target}, and a second time, t₂ seconds, from the key-on event for the second exhaust gas temperature sensor 24 to reach the target temperature T_{target} are both recorded. According to several aspects the target temperature T_{target} is approximately 275 degrees Centigrade, however this temperature can range between approximately 150 degrees Centigrade to 350 degrees Centigrade as desired.

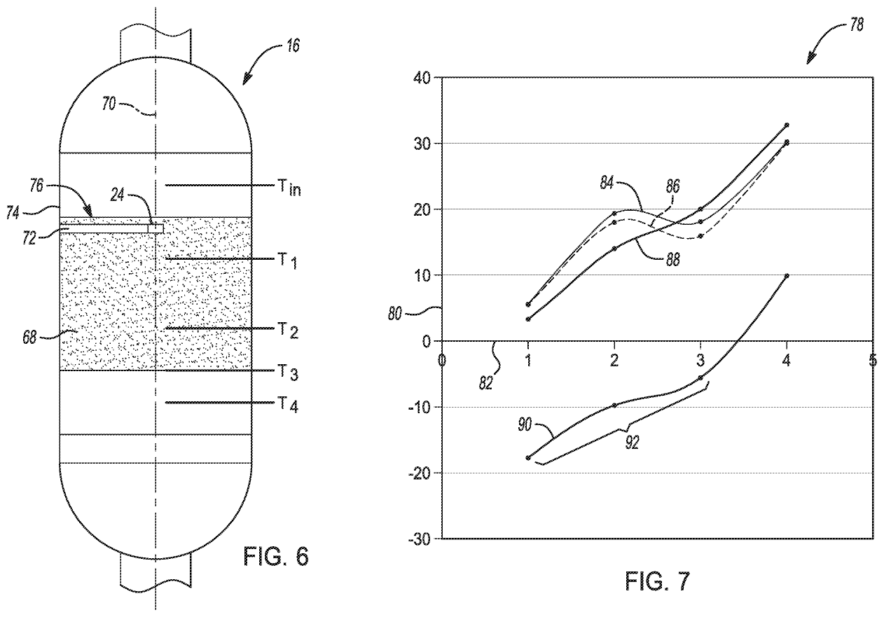

If the DOC device 16 is functioning properly, the second exhaust gas temperature sensor 24 should reach the target temperature T_{target} prior to the first exhaust gas temperature sensor 22 measuring the inlet gas temperature reaching the target temperature. The first time t₁ is compared to the second time t₂, and if the test conditions are satisfied with the second exhaust gas temperature sensor 24 reaching the target temperature T_{target} before the first exhaust gas temperature sensor 22 reaches the target temperature T_{target}, the DOC device 16 is considered to be functioning properly and a healthy DOC signal is generated. Conversely, if the time for the inlet gas temperature to reach the target temperature is less than the time required for the brick temperature of the catalyst coated body (described in reference to FIG. 6) to reach the same target temperature, a DOC un-healthy signal is generated.

Referring to FIG. 3 and again to FIGS. 1 through 2, from a cold engine 12 start, the exhaust treatment system 10 can also function as follows using the modeled inlet brick temperature 38 in place of the temperature signal from the first exhaust gas temperature sensor 22. When the ignition is keyed on, the control module 36 begins recording the output from the second exhaust gas temperature sensor 24. The second time t2 from the key-on event for the second exhaust gas temperature sensor 24 to reach the target temperature T_{target} is recorded. According to several aspects the target temperature T_{target} is approximately 275 degrees Centigrade as previously noted. If the DOC device 16 is functioning properly, the second exhaust gas temperature sensor 24 should reach the target temperature T_{target} prior to the modeled inlet brick temperature 38 reaching the target temperature T_{target}. The modeled inlet brick temperature 38 is then compared to the second time t2, and if the test conditions are satisfied with the second exhaust gas temperature sensor 24 reaching the target temperature T_{target} before the modeled inlet brick temperature 38 reaches the same target temperature T_{target}, the DOC device 16 is considered to be functioning properly and a healthy DOC signal is generated. Similar to the above, if the time for the modeled inlet brick temperature 38 to reach the target temperature is less than the time required for the brick temperature of the catalyst coated body to reach the same target temperature, a DOC un-healthy signal is generated.

The following modeling equation is used to estimate the brick temperature at the inlet face 38 from the measured inlet gas temperature and a total heat capacity of a coated DOC device 16:

$${Ψ}_{s} \frac{\partial {T}_{s}}{\partial t} = hS ( {T}_{g , in} - {T}_{s} )$$

Ψₛ=total heat capacity of the washcoated substrate

h=gas-solid heat transfer coefficient

S=geometric surface area per unit coverter volume

Tₛ=converter bed temperature at monolith inlet

T_{g,in}=temperature of gas measured near monolith inlet

The bed temperature of the calculated or modeled inlet brick temperature Ts is determined from the following equation:

Tₛ(t)=e^{-0.93}[Tₛ(0)+0.93 ∫₀^{t}T_{g,in}(T)e^{-0.93T}dT)

where the calculated inlet brick temperature Tₛ is for an infinitesimally small converter volume based on the inlet gas temperature (T_{g,in}). Using the calculated inlet brick temperature Tₛ provides an advantage over using the measured temperature from the first exhaust gas temperature sensor 22 and the time t₁ to reach the target temperature because the calculated inlet brick temperature Tₛ would be expected to increase monotonically during cold engine 12 start periods and is less sensitive to abrupt changes in vehicle driving conditions, and therefore provides a more robust detection of the state of the DOC device 16 health.

Sources of DOC heat include:
1) convective heat associated with incoming hot exhaust gas; and
2) exothermic heat generated when hydrocarbons and CO in the exhaust gas are oxidized over the DOC.
   Oxidation occurs at higher temperatures for a poorly performing DOC than a properly performing DOC device. Retained hydrocarbons from previous operation should be released and oxidized over the DOC device. This does not occur in a poorly performing DOC device. The DOC brick temperature exceeds the inlet gas temperature once a properly performing DOC device lights-off, oxidizing hydrocarbons. For a poorly performing DOC device, neither the brick temperature nor the outlet gas temperature exceed the inlet gas temperature within the first approximate 2 minutes of DOC device operation. The inlet gas temperature can fluctuate depending on vehicle driving conditions, but the brick temperature slowly and monotonically rises.

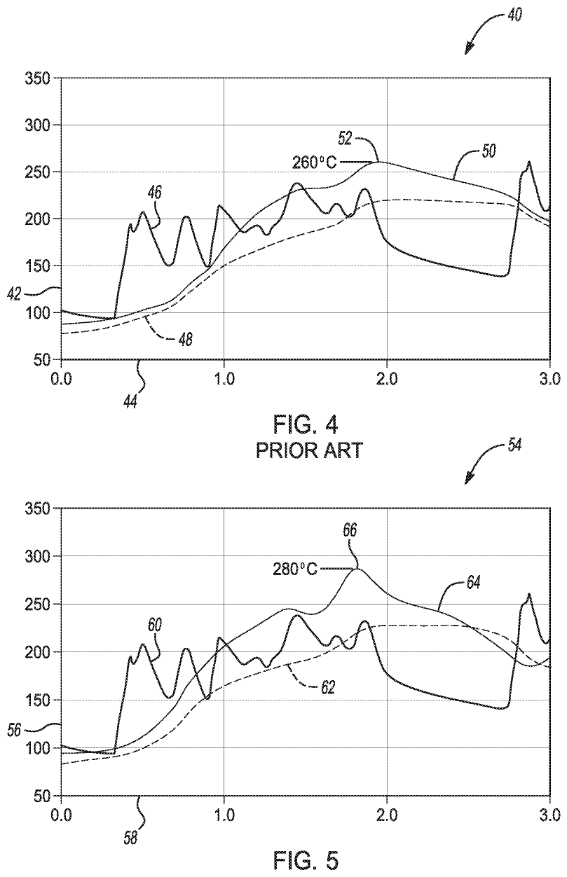

Referring to FIG. 4, a graph 40 presents a temperature range 42 in degrees Centigrade and a time 44 in minutes to compare outlet gas temperatures from several DOC devices known in the art. A first curve 46 identifies a DOC gas inlet temperature. A second curve 48 presents outlet gas temperatures of a poorly performing DOC device, wherein the outlet gas temperature does not exceed the inlet gas temperature during the first two minutes of DOC operation. A third curve 50 presents outlet gas temperatures of a properly performing DOC device, wherein the outlet gas temperature exceeds the inlet gas temperature during the first two minutes of DOC operation, and reaches a peak temperature 52 of approximately 260 degrees Centigrade.

Referring to FIG. 5 and again to FIG. 4, a graph 54 presents a temperature range 56 in degrees Centigrade and a time 58 in minutes to compare brick temperatures of several DOC devices. A first curve 60 identifies a DOC gas inlet temperature. A second curve 62 presents brick temperatures of a poorly performing DOC device, wherein the brick temperature does not exceed the inlet gas temperature during the first two minutes of DOC operation. A third curve 64 presents brick temperatures of a properly performing DOC device, wherein the brick temperature exceeds the inlet gas temperature during the first two minutes of DOC operation, and reaches a peak temperature 66 of approximately 280 degrees Centigrade. With continuing reference to both FIGS. 4 and 5, the maximum temperature reached by a properly operating DOC device based on outlet gas temperature (260 degrees Centigrade) is less than the maximum brick temperature (280 degrees Centigrade) of a properly operating DOC device during the same two minute period of initial operation. Because the temperature difference is more pronounced using the brick temperature, it is evident that brick temperature provides a more sensitive indication than outlet gas temperature with respect to determining the health of a DOC device.

Referring to FIG. 6, according to several aspects, the second exhaust gas temperature sensor 24 is embedded within a catalyst coated body 68 of the DOC device 16 and measures the oxidation catalyst temperature, or brick temperature within the DOC device 16. According to several aspects, the second exhaust gas temperature sensor 24 is positioned substantially along a longitudinal centerline 70 of the catalyst coated body 68 of the DOC device 16 by first creating an aperture or bore 72 through an outer wall 74 of the DOC device 16 which extends into the catalyst coated body 68. The second exhaust gas temperature sensor 24 is fixed in position within the bore 72 for example using an adhesive to fix the second exhaust gas temperature sensor 24 proximate to an upstream or inlet face 76 of the catalyst coated body 68 or DOC brick and to fill a remainder of the bore 72. According to further aspects, the second exhaust gas temperature sensor 24 can be located at any axial distance into the DOC brick, and does not need to be positioned proximate to the inlet face 76 of the DOC brick 68.

An inlet gas temperature Tᵢₙ upstream of the catalyst coated body 68 defines the inlet gas temperature measured by the first exhaust gas temperature sensor 22 previously discussed. To confirm how a brick temperature of the catalyst coated body 68 is differentiated from the upstream gas temperature sensed by the position of the first exhaust gas temperature sensor 22, various temperature sensing positions are presented over a cross section of the DOC device 16 along the longitudinal centerline 70 of the catalyst coated body 68. Three brick temperature sensor positions T₁, T₂, T₃ are shown at successive locations within the catalyst coated body 68 along the longitudinal centerline 70, and an outlet temperature position T4 is located downstream of the catalyst coated body 68.

Referring to FIG. 7 and again to FIG. 6, a graph 78 shows a time 80 in seconds it takes for the catalyst bed to reach the target temperature of 275 degrees Centigrade along a plot line 82 presenting data points 1, 2, 3, 4 for each of the three successive temperature sensor positions T₁, T₂, T₃ and the outlet temperature position T₄ presented in FIG. 6. A first curve 84 and a second curve 86 represent poorly performing DOC devices with one lacking additional pre-stored hydrocarbons and one including additional pre-stored hydrocarbons on the catalyst. A third curve 88 represents a properly performing DOC device of the present disclosure having a temperature sensor embedded within the catalyst coated body 68, however this DOC device also lacks any pre-stored hydrocarbons to provide sufficient reaction exotherm during DOC light-off. None of the first curve 84, the second curve 86, or the third curve 88 identify the ability of the catalyst coated body 68 of the DOC device at any of the temperature sensor positions T₁, T₂, T₃ or the outlet temperature position T₄ to reach 275 degrees Centigrade before the inlet gas Tᵢₙ reaches 275 degrees Centigrade.

A fourth curve 90 presents results using a DOC device of the present disclosure having a temperature sensor such as the second exhaust gas temperature sensor 24 embedded within the catalyst coated body 68, and with the presence of additional hydrocarbons pre-stored on the catalyst coating in the catalyst coated body 68 to provide additional hydrocarbon material to help initiate the catalyst exothermic reaction. Only the fourth curve 90 indicates that the brick temperature of the catalyst coated body 68 reaches 275 degrees Centigrade prior to the inlet gas reaching 275 degrees Centigrade. Each of the three successive temperature sensor positions T₁, T₂, T₃ within a curve portion 92 meet this criteria with the additional hydrocarbon storage provided, therefore the use of the brick temperature together with the addition of stored hydrocarbons in the catalyst bed reflects DOC health better than the measurement of the outlet gas temperature.

A vehicle on-board diagnostic method for monitoring diesel oxidation catalyst function via a brick temperature rise of the present disclosure offers several advantages. These include providing an inlet gas sensor to directly measure an inlet gas temperature or a model-based method to estimate an inlet gas temperature, and comparing the inlet gas temperature to a brick temperature of a catalyst coated body of a DOC device to determine the health of the DOC device. An exhaust gas temperature sensor is embedded within the catalyst body of the DOC device to directly measure the catalyst brick temperature.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for monitoring diesel oxidation catalyst function via a brick temperature rise, comprising:
positioning a diesel oxidation catalyst (DOC) exhaust treatment device in an exhaust conduit receiving exhaust from a diesel engine, the DOC exhaust treatment device having a catalyst coated body;
measuring an inlet gas temperature to the DOC exhaust treatment device and forwarding the inlet gas temperature to a control module;
recording a time for the inlet gas temperature to reach a target temperature in the control module; and
comparing in the control module the time for the inlet gas temperature to reach the target temperature to a time required for a brick temperature of the catalyst coated body to reach the same target temperature.

2. The method of claim 1, wherein the determining step further includes positioning a first exhaust gas temperature sensor in the exhaust conduit upstream of the DOC exhaust treatment device.

3. The method of claim 2, further including positioning a second exhaust gas temperature sensor within the catalyst coated body, an output signal from the second exhaust gas temperature sensor forwarded to the control module and defining the brick temperature of the catalyst coated body.

4. The method of claim 3, further including:
creating a bore in the catalyst coated body adapted to receive the second exhaust gas temperature sensor; and
fixing the second exhaust gas temperature sensor within the bore.

5. The method of claim 4, further including positioning the second exhaust gas temperature sensor within the bore proximate to a longitudinal centerline of the catalyst coated body.

6. The method of claim 1, further including storing hydrocarbons on a catalyst coating in the catalyst coated body.

7. The method of claim 6, wherein the determining step further includes measuring the brick temperature.

8. The method of claim 1, wherein the determining step further includes predicting a temperature immediately inside an inlet face of the DOC exhaust treatment device via a mathematical model using the measured inlet gas temperature.

9. The method of claim 8, further including:
generating the brick temperature of the catalyst coated body using an exhaust gas temperature sensor positioned within the catalyst coated body; and
forwarding an output signal from the exhaust gas temperature sensor to the control module.

10. The method of claim 9, further including:
creating a bore in the catalyst coated body adapted to receive the exhaust gas temperature sensor; and
positioning the exhaust gas temperature sensor within the bore.

11. A method for monitoring diesel oxidation catalyst function via a brick temperature rise, comprising:
pre-storing hydrocarbons on a catalyst coating in a catalyst coated body;
positioning a diesel oxidation catalyst (DOC) exhaust treatment device in an exhaust conduit of a diesel engine, the DOC exhaust treatment device including the catalyst coated body;
forwarding a first exhaust gas temperature output defining an inlet gas temperature received in the DOC exhaust treatment device to a control module;
recording in the control module a time for the inlet gas temperature to reach a target temperature; and
comparing in the control module the time for the inlet gas temperature to reach the target temperature to a time required for a brick temperature of the catalyst coated body to reach the same target temperature.

12. The method of claim 11, further including positioning a first exhaust gas temperature sensor in the exhaust conduit upstream of the DOC exhaust treatment device to measure the first exhaust gas temperature output.

13. The method of claim 12, further including positioning a second exhaust gas temperature sensor within the catalyst coated body to generate the brick temperature of the catalyst coated body.

14. The method of claim 11, wherein the target temperature is approximately 275 degrees Centigrade.

15. The method of claim 11, wherein the target temperature ranges between approximately 150 degrees Centigrade to 350 degrees Centigrade.

16. The method of claim 11, wherein if the time for the brick temperature of the catalyst coated body to reach the target temperature is less than the time for the inlet gas temperature to reach the same target temperature, a DOC healthy signal is generated by the control module.

17. The method of claim 11, wherein if the time for the inlet gas temperature to reach the target temperature is less than the time required for the brick temperature of the catalyst coated body to reach the same target temperature, a DOC un-healthy signal is generated by the control module.

18. A method for monitoring diesel oxidation catalyst function via a brick temperature rise, comprising:
providing a first exhaust gas temperature sensor outputting a first exhaust gas temperature for an exhaust conduit collecting exhaust from a diesel engine;
positioning a diesel oxidation catalyst (DOC) exhaust treatment device in the exhaust conduit downstream of the first exhaust gas temperature sensor, the DOC exhaust treatment device having a catalyst coated body;
incorporating a second exhaust gas temperature sensor in the catalyst coated body of the DOC exhaust treatment device;
forwarding an output signal from each of the first exhaust gas temperature sensor defining an inlet gas temperature received in the DOC exhaust treatment device, and an output signal from the second exhaust gas temperature sensor defining a brick temperature of the catalyst coated body to a control module;
recording in the control module a time for the inlet gas temperature to reach a target temperature; and
comparing in the control module the time for the inlet gas temperature to reach the target temperature to a time required for the brick temperature of the catalyst coated body to reach the same target temperature.

19. The method of claim 18, wherein:
if the time for the brick temperature of the catalyst coated body to reach the target temperature is less than the time for the inlet gas temperature to reach the same target temperature a DOC healthy signal is generated; or
if the time for the inlet gas temperature to reach the target temperature is less than the time required for the brick temperature of the catalyst coated body to reach the target temperature a DOC un-healthy signal is generated.

20. The method of claim 18, further including incorporating the second exhaust gas temperature sensor in a bore of the catalyst coated body along a longitudinal axis of the catalyst coated body.
